(19) United States
(12) Patent Application Publication
(10) Pub. No.: US 2009/0139906 A1
(43) Pub. Date: Jun. 4, 2009

(54) ISOELECTRIC SEPARATION OF OIL SANDS

(76) Inventor: Jan Kruyer, Thorsby (CA)

Correspondence Address: THORPE NORTH & WESTERN, LLP., P.O. Box 1219, SANDY, UT, 84091-1219, US

(21) Appl. No.: 11/948,851

(22) Filed: Nov. 30, 2007

(51) Int. Cl. B03B 5/36

(52) U.S. Cl. 208/391; 210/167.01

(57) ABSTRACT

A process and system for substantially isoelectric separation of an oil sand slurry is disclosed and described. The process can include mining oil sand, crushing the oil sands, forming a slurry of the oil sands, and transporting the oil sands slurry to a sinusoidal pipe. The sinusoidal pipe acts to digest the slurry from which bitumen can be separated using a hydrocyclone. Overflow from the hydrocyclone can be further treated using a revolving oleophilic device from which bitumen is recovered. Various optional further treatments can be used to dewater and/or further treat the bitumen and other process streams. The use of caustic soda, long-term tailing ponds, and froth flotation can be avoided resulting in an effective production of oil using less water than currently conventional processes.

### RELATED APPLICATIONS

This application is related to U.S. patent application Ser. No. 11/939,978 entitled “Sinusoidal Mixing and Shearing Apparatus and Associated Methods,” filed Nov. 14, 2007 (hereinafter referred to as “Sinusoidal Mixing Application”), Ser. No. 11/940,099 entitled “Hydrocyclone and Associated Methods,” filed Nov. 14, 2007 (hereinafter referred to as “Hydrocyclone Application”), and Ser. No. 11/948,816 entitled “Endless Cable System and Associated Methods,” filed Nov. 30, 2007 (hereinafter referred to as “Endless Cable Application”) which are each incorporated herein by reference.

### FIELD OF THE INVENTION

The present invention relates to processes and systems for processing oil sands from mining the ore to cleaning the produced bitumen. Specifically the present invention relates to isoelectric separation of oil sand and the associated use of an oleophilic endless belt formed from one or more endless cable systems wrapped in spaced configuration a multitude of times around two or more drums. Accordingly, the present invention involves the fields of process engineering, chemistry, and chemical engineering.

### BACKGROUND OF THE INVENTION

According to some estimates, oil sands, also known as tar sands or bituminous sands, may represent up to two-thirds of the world's petroleum. Oil sands resources are relatively untapped. Perhaps the largest reason for this is the difficulty of extracting bitumen from the sands. Mineable oil sand is found as an ore in the Fort McMurray region of Alberta, Canada, and elsewhere. This oil sand includes sand grains having viscous bitumen trapped between the grains. The bitumen can be liberated from the sand grains by slurrying the as-mined oil sand in water so that the bitumen flecks move into the aqueous phase for separation. For the past 40 years, bitumen in McMurray oil sand has been commercially recovered using the original Clark Hot Water Extraction process, along with a number of improvements. Karl Clark invented the original process at the University of Alberta and at the Alberta Research Council around 1930 and improved it for over 30 years before it was commercialized.

In general terms, the conventional hot water process involves mining oil sands by bucket wheel excavators or by draglines at a remote mine site. The mined oil sands are then conveyed, via conveyor belts, to a centrally located bitumen extraction plant. In some cases, the conveyance can be as long as several kilometers. Once at the bitumen extraction plant, the conveyed oil sands are conditioned. The conditioning process includes placing the oil sands in a conditioning tumbler along with steam, water, and caustic soda in an effort to disengage bitumen from the sand grains of the mined oil sands. Further, conditioning is intended to remove oversize material for later disposal. Conditioning forms a hot, aerated slurry for subsequent separation. The slurry can be diluted for additional processing, using hot water. The diluted slurry is then pumped into a primary separation vessel (PSV). The diluted hot slurry is then separated by flotation in the PSV. Separation produces three components: an aerated bitumen froth which rises to the top of the PSV; primary tailings, including water, sand, silt, and some residual bitumen, which settles to the bottom of the PSV; and a middlings stream of water, suspended clay, and suspended bitumen. The bitumen froth can be skimmed off as the primary bitumen product. The middlings stream can be pumped from the middle of the PSV to sub-aeration flotation cells to recover additional aerated bitumen froth, known as a secondary bitumen product. The primary tailings from the PSV, along with secondary tailings product from flotation cells are pumped to a tailings pond, usually adjacent to the extraction plant, for impounding. The tailings sand can be used to build dykes around the pond and to allow silt, clay, and residual bitumen to settle for a decade or more, thus forming non-compacting sludge layers at the bottom of the pond. Clarified water eventually rises to the top for reuse in the process.

The bitumen froth is treated to remove air. The deaerated bitumen froth is then diluted with naptha and centrifuged to produce a bitumen product suitable for upgrading. Centrifuging also creates centrifugal tailings that contain solids, water, residual bitumen, and naptha, which can be disposed of in the tailings ponds.

After the process became commercial, about 40 years of research and many millions of dollars have been devoted to improving the Clark process by several commercial oil sands operators, and by the Alberta government. Research has largely been focused on improving the process and overcoming some of the major pitfalls associated with the original Clark process. Some of the major pitfalls are:

1. Major bitumen losses from the conditioning tumbler, from the PSV and from the subaeration cells.

2. Reaction of hot caustic soda with mined oil sands result in the formation of naphthenic acid detergents, which are extremely toxic to marine and animal life, and require strict and costly isolation of the tailings ponds from the environment for at least many decades.

3. Huge energy losses due to the need to heat massive amounts of mined oil sands and massive amounts of water to achieve the required separation, which energy is then discarded to the ponds.

4. Loss of massive amounts of water taken from water sources, such as the Athabasca river, for the extraction process and permanently impounded into the tailings ponds that can not be returned to the water sources on account of its toxicity. For example, to produce one barrel of oil requires over 2 barrels of water from the Athabasca River.

5. The cost of constructing and maintaining a large separation plant.

6. The cost of transporting mined oil sands from a remote mining location to a large central extraction plant by means of conveyors. Additionally, the conveyors can be problematic.

7. The cost of dilution centrifuging.

8. The cost of naphtha recovery.

9. The cost of maintaining and isolating huge tailings ponds.

10. The cost of preventing leakage of toxic liquids from the tailings ponds.

11. The cost of government fines when environmental laws are breached.

12. The eventual cost of remediation of mined out oil sands leases and returning these to the environment in a manner acceptable to both the Alberta and the Canadian government.

13. The environmental impact of the tailings ponds.

Some major improvements have been made that included lowering the separation temperature in the tumbler, the PSV, and the flotation cells. This reduced the energy costs to a degree but may also require the use of larger tumblers and the addition of more air to enhance bitumen flotation. Another improvement eliminated the use of bucket wheel excavators, draglines and conveyor belts to replace these with large shovels and huge earth moving trucks, and then later to replace some of these trucks with a slurry pipeline to reduce the cost of transporting the ore from the mine site to the separation plant. Slurry pipelines eliminate the need for conditioning tumblers but require the use of oil sand crushers to prevent pipe blockage and require cyclo-feeders to aerate the oil sand slurry as it enters the slurry pipeline, and may also require costly compressed air injection into the pipeline. Other improvements included tailings oil recovery units to scavenge additional bitumen from the tailings, and naptha recovery units for processing the centrifugal tailings before these enter the tailings ponds.

More recent research is concentrating on reducing the separation temperature of the Clark process even further and on adding gypsum or flocculants to the sludge of the tailings ponds to compact the fines and release additional water. Most of these improvements have served to increase the amount of bitumen recovered and reduce the amount of energy required, but have increased the complexity and size of the commercial oil sands plants.

One particular problem that has vexed commercial mined oil sands plants is the problem of fine tailings disposal. In the current commercial process, mined oil sands are mixed and stirred with hot water, air, and caustic soda to form a slurry that is subsequently diluted with cooler water and separated in large separation vessels. In these vessels, air bubbles attach to bitumen droplets of the diluted slurry and cause bitumen product to float to the top for removal as froth. Caustic soda serves to disperse the fines to reduce the viscosity of the diluted slurry and allows the aerated bitumen droplets to travel to the top of the separation vessels fast enough to achieve satisfactory bitumen recovery in a reasonable amount of time. Caustic soda serves to increase the pH of the slurry and thereby imparts electric charges to the fines, especially to the clay particles, to repel and disperse these particles and thereby reduce the viscosity of the diluted slurry.

Without caustic soda, for most oil sands the diluted slurry would be too viscous for effective bitumen recovery. It can be shown from theory or in the laboratory that for an average oil sand, it takes five to ten times as long to recover the same amount of bitumen if no caustic soda is added to the slurry. Such a long residence time would make commercial oil sands extraction much more expensive and impractical.

While caustic soda is beneficial as a viscosity breaker in the separation vessels for floating off bitumen, it is environmentally very detrimental. At the high water temperatures used during slurry production it reacts with naphthenic acids in the oil sands to produce detergents that are highly toxic. Not only are the tailings toxic, but also the tailings fines will not generally compact. Tailings ponds with a circumference as large as 20 kilometers are required at each large mined oil sands plant to contain the fine tailings. Coarse sand tailings are used to build huge and complex dyke structures around these ponds.

Due to the prior addition of caustic soda, the surfaces of the fine tailings particles are electrically charged, which in the ponds, causes the formation of very thick layers of microscopic card house structures that compact extremely slowly and take decades or centuries to dewater. Many millions of dollars per year have been and are being spent in an effort to maintain the tailings ponds and to find effective ways to dewater these tailings. Improved mined oil sands processes must be commercialized to overcome the environmental problems of the current plants. One such alternate method of oil sands extraction is the Kruyer Oleophilic Sieve process invented in 1975.

Like the Clark Hot Water process, the Kruyer Oleophilic Sieve process originated at the Alberta Research Council and a number of Canadian and U.S. patents were granted to Kruyer as he privately developed the process for over 30 years. The first Canadian patent of the Kruyer process was assigned to the Alberta Research Council and all subsequent patents remain the property of Kruyer. Unlike the Clark process, which relies on flotation of bitumen froth, the original Kruyer process used a revolving apertured oleophilic wall (trademarked as the Oleophilic Sieve) and passed the oil sand slurry to the wall to allow hydrophilic solids and water to pass through the wall apertures whilst capturing bitumen and associated oleophilic solids by adherence to the surfaces of the revolving oleophilic wall.

Along the revolving apertured oleophilic wall, there are one or more separation zones to remove hydrophilic solids and water and one or more recovery zones where the recovered bitumen and oleophilic solids are removed from the wall. This product is not an aerated froth but a viscous liquid bitumen.

A bitumen-agglomerating step may be required to increase the bitumen particle size before the slurry passes to the apertured oleophilic wall for separation. Attention is drawn to the fact that in the Hot Water Extraction process the term “conditioning” is used to describe a process wherein oil sands are gently mixed with controlled amounts water in such a manner as to entrain air in the slurry to eventually create a bitumen froth product from the separation. The Oleophilic Sieve process also produces a slurry when processing mined oil sands but does not “condition” it. Air is not required, nor desired, in the Oleophilic Sieve process. As a result, the slurry produced for the Oleophilic Sieve, as well as the separation products, are different from those associated with the conventional Hot Water Extraction process. The Kruyer process was tested extensively and successfully implemented in a pilot plant with high grade mined oil sands (12 wt % bitumen), medium grade mined oil sands (10 wt % bitumen), low grade oil sands (6 wt % bitumen) and with sludge from commercial oil sands tailings ponds (down to 2% wt % bitumen), the latter at separation temperatures as low as 5° C. A large number of patents are on file for the Kruyer process in the Canadian and U.S. Patent Offices. These patents include: CA 2,033,742; CA 2,033,217; CA 1,334,584; CA 1,331,359; CA 1,144,498 and related U.S. Pat. No. 4,405,446; CA 1,141,319; CA 1,141,318; CA 1,132,473 and related U.S. Pat. No. 4,224,138; CA 1,288,058; CA 1,280,075; CA 1,269,064; CA 1,243,984 and related U.S. Pat. No. 4,511,461; CA 1,241,297; CA 1,167,792 and related U.S. Pat. No. 4,406,793; CA 1,162,899; CA 1,129,363 and related U.S. Pat. No. 4,236,995; and CA 1,085,760.

While in a pilot plant, the Kruyer process has yielded higher bitumen recoveries, used lower separation temperatures, was more energy efficient, required less water, did not produce toxic tailings, used smaller equipment, and was more movable than the Clark process. There were a number of drawbacks, though, to the Kruyer process. One drawback to the Kruyer process is related to the art of scaling up. Scaling up a process from the pilot plant stage to a full size commercial plant normally uncovers certain engineering deficiencies of scale such as those identified below.

Commercial size apertured drums that may be used as revolving apertured oleophlilic walls require very thick perforated steel walls to maintain structural integrity. Such thick walls increase retention of solids by the bitumen and may degrade the resulting bitumen product. Alternately, apertured mesh belts may be used as revolving apertured oleophilic walls. These have worked well in the pilot plant but after much use, have tended to unravel and fall apart. This problem will likely be exacerbated in a commercial plant running day and night. Rugged industrial conveyor belts are available. These are made from pre-punched serpentine strips of flat metal and then joined into a multitude of hinges by cross rods to form a rugged industrial conveyor belt. Other industrial metal conveyor belts are made from flattened coils of wire and then joined into a multitude of hinges by cross rods to form the belts. Both types of metal belts were tested and have stood up well in a pilot plant. However, it was difficult and energy intensive to remove most of the bitumen product in the recovery zone from the surfaces of the belts before these revolved back to the separation zone.

Bitumen agglomerating drums using oleophilic free bodies, in the form of oleophilic balls that tumbled inside these drums worked very well in the pilot plant. However commercial size agglomerators using tumbling free bodies may require much energy and massive drum structures to contain a revolving bed of freely moving heavy oleophilic balls with adhering viscous cold bitumen to achieve the desired agglomeration of dispersed bitumen particles.

### SUMMARY OF THE INVENTION

While the chemistry of oil sand separation is very complex and has been studied for over 60 years a simplified description is here provided explaining the unique features whereby the systems disclosed and claimed in the instant invention can overcome some of the problems of the prior art developed by Karl Clark and improved by subsequent researchers.

As explained, the Clark process relies on bitumen flotation to separate oil sand slurries. However, bitumen has the same density as water at room temperature and, as such, unaided bitumen droplets or flecks will not rise in an aqueous environment. Bitumen expands more rapidly than water with increasing temperature and only after the slurry is brought to an elevated temperature will bitumen have a tendency to float to the top of a separation vessel. But without the use of a caustic process aid, most oil sand slurries are so viscous that the rate of ascent of bitumen droplets through a diluted viscous slurry in the separation vessels of the Clark process is so slow that inordinately long residence times would be required in the separating equipment to achieve acceptable bitumen recoveries.

Sodium hydroxide, the process aid normally used in small amounts during slurry preparation generally results in dispersed slurries with a pH of about 8.5 and gives commercially acceptable bitumen flotation recoveries for most oil sands. As part of the slurry making process, air normally is trapped in the form of tiny bubbles to which bitumen droplets or flecks attach themselves to help in their ascent. Also air may be added elsewhere in the process. The resulting product is a bitumen froth, which rises to the top of the vessels and is skimmed off for further clean up and processing.

Salts, chemicals, humic matter, minerals and heavy minerals have a tendency to reduce the effectiveness with the Clark process, either by interfering with the slurry dispersion mechanism or by inclusion in or adhesion to bitumen droplets or flecks, making these droplets too heavy to float and causing them to report to the tailings, thereby reducing overall bitumen recovery. Clay particles and heavy minerals, for example, titanium and zirconium oxides widely distributed in Alberta oil sands have a tendency to adhere to bitumen and, when there is insufficient attachment of bitumen to air bubbles which aid in the flotation process, such deficiency can result in significant loss of bitumen to the tailings. This is particularly true for low-grade oil sand ores rich in fines.

The process aid required in the Clark process for most oil sands has a detrimental effect on the tailings or effluents. During processing at elevated temperatures sodium hydroxide (caustic) releases and reacts with naphthenic acids naturally present in oil sand ores and causes the tailings to become highly toxic. As a result, tailings water from the Clark process, according to current Alberta environmental law, may not be returned to the environment but must be impounded.

After the fines of an oil sand slurry are dispersed, and bitumen froth has been recovered in the Clark process, the fines in the resulting toxic tailings remain dispersed and must be kept isolated from the environment. Accordingly the tailings flow into a tailings pond where coarse sand drops out on a gently sloping beach and is scraped up to form huge dykes to contain the remaining water and fines. Some dykes may be up to hundreds of meters high. Fines settle in the pond water and, after months or years, form microscopic gel like card house structures of electrically charged platelets. These structures can take decades or centuries to compact and thereby trap and retain large amounts of water. Hence, the result of adding a caustic process aid in the Clark process is the accumulation of huge single or multiple tailings ponds beside each mined oil sand plant; some of which may encompass a total area 20 kilometers in circumference. Clarified water will eventually rise to the top of a tailings pond and may be reused by the oil sands plant but normally only after years of operation.

A recent commercial trend is to allow the fines to settle in the pond and then, after maturing for a decade or more to pump the mature settled fines from the pond and mix these with gypsum in an effort to compact the card house structures to release some of the trapped water. Coarse sand may then be mixed with these compacted fines to form a wet mixture that may be disposed into the mined out portions of the oil sands lease. The released water may be toxic still and is hard water containing calcium and normally would require treatment before it can be reused in the commercial plant.

Although, froth flotation is a commercially accepted method of bitumen recovery from mined oil sands, it is not environmentally friendly. It requires many steps, vessels, controls and processes to achieve acceptable bitumen recovery and subsequently requires many steps controls and processes to isolate or overcome the environmental problems that were generated to achieve this acceptable bitumen recovery. As a result, environmental remediation of a mined out oil sands lease is very costly and may never be fully accomplished.

As will be described in more detail below, the systems and processes of the present invention allow for the elimination of caustic, process aids, and added air. The system disclosed and claimed in the instant invention overcomes many of the problems described above. Environmentally it is a more beneficial system, e.g. the tailings water is not toxic and can be reused in the process without major treatment. The system generally requires less energy, less water, less chemicals, fewer steps and less equipment to achieve the same or better bitumen recovery.

Bitumen flotation is not used and caustic process aid is not used. Instead of by flotation, the oil sand slurry is separated by screening out bitumen by an oleophilic endless belt formed by multiple wraps of an endless cable formed of a suitable oleophilic material such as, but not limited to, steel, carbon fiber, plastic or other material having sufficient mechanical strength and abrasion resistance. Bitumen adheres to the cable whilst water, sand and fines pass through the slits or spaces between the cable wraps to dewatering, to disposal or to further optional processing. The adhering bitumen is subsequently removed from the cable wraps in a recovery zone, not as bitumen froth but as viscous liquid bitumen. The liquid bitumen may then be cleaned effectively in one or more subsequent system steps.

In summary, the system of the instant invention approaches oil sands separation from a completely different angle than the commercial Clark process. Instead of using air to float bitumen from dispersed slurry, and instead of using a caustic process aid that results in major environmental concerns downstream from the plant, the instant invention screens the bitumen out of oil sand slurry at or close to isoelectric conditions using long lasting abrasion resistant endless cables. That means the fines do not have to be dispersed by increasing the natural pH of the oil sand ore. Bitumen droplets or flecks are not encouraged to float and air entrainment is not required since flotation is not used. Naphthenic acids naturally present in oil sands are not released by nor reacted with sodium hydroxide and the resulting tailings are much less toxic. Tailings water produced by the present invention will do much less damage to the environment. Gel like card-house structures of tailings fines in tailings ponds or during dewatering are reduced or eliminated. Tailings dewater more rapidly and water from the tailings is readily recycled in the process without major treatment. Over the lifespan of an oil sands plant, fresh water requirements for processing oil sands are significantly lower. For example, in the current commercial bitumen flotation processes about two barrels of water are removed from the environment to produce one barrel of bitumen. In the process of the instant invention, due to process water recycle, the water requirements on a quarterly basis are less than one barrel of water per barrel of bitumen produced. Additional water may be recovered and re-used as tailings dewatering continues thereafter to further reduce these water requirements. Large tailings ponds can also be eliminated. The costs of oil sand lease environmental remediation are lower. Less energy is lost to the tailings ponds. Carbon dioxide production is well below 30 kilograms of carbon dioxide per barrel of bitumen produced as compared with 45 kilograms for the Clark process for mined oil sands and 95 kilograms for recovering bitumen from deep deposits by the steam assisted gravity drainage (SAGD) process. The Kruyer process is simpler, more portable, and is useful for separations at the surface or for partial separations underground in a mineshaft or under overburden. Water requirements are lower and the costs to recover a barrel of bitumen from oil sands is lower than for the Clark process.

In one embodiment of the instant invention, isoelectric or nearly isoelectric separation of an oil sand slurry can include mining of the oil sand ore, on the surface or underground. The mined ore can be transported to a crusher, where the ore can be crushed to a size suitable for unobstructed pipeline slurry transport. Coarse rocks and large lumps can be screened, if required, and the resulting material can be mixed with water to form a slurry. The slurry can be transported through a pipe or pipeline, a portion of which optionally includes a sinusoidal pipe or pipeline configured to digest the slurry into discrete bitumen and solids particles dispersed in an aqueous medium. The digested slurry can be further subjected to coarse screening to remove large rocks and undigested lumps, if needed, prior to entry into one or more hydrocyclones. The digested and/or screened slurry can be passed through one or more hydrocyclones to produce an aqueous underflow of coarse solids including sand and a generally de-sanded aqueous overflow of bitumen droplets and fine solids. The underflow can be dewatered, either with a revolving belt filter or by allowing water to be run off and to be collected at a short term tailings pond. Furthermore, the overflow can be passed to and/or through a revolving endless oleophilic belt formed from multiple wraps of one or more endless cables to produce continuous phase viscous liquid bitumen product containing dispersed water, oleophilic and hydrophilic solids, while yielding a generally de-sanded tailings product for dewatering and disposal. The de-sanded tailings product can be dewatered, either with a revolving belt filter or by use of a short term tailings pond. System water collected from the underflow and from the de-sanded tailings can be optionally reused. The continuous phase viscous liquid bitumen product can be processed further to remove hydrophilic solids. This is done by dispersing the viscous liquid bitumen product in water using one or more pumps and pipes including one or more static mixers such as sinusoidal pipes. The resulting dispersed bitumen product in a continuous water phase can be passed to and/or through a revolving endless oleophilic belt formed from multiple wraps of one or more endless cables to produce a viscous bitumen product from which a large portion of its hydrophilic solids has thus been removed, yielding tailings that have passed through the belt gaps for disposal.

Various optional pumps, static mixers and hydrocyclones can be used, in addition, to further mix and process viscous liquid bitumen product with paraffinic hydrocarbon to remove water, solids and heavy asphaltenes from the viscous liquid bitumen product of the endless cable belt of the instant invention and make it suitable for long distance pipeline transport or for upgrading to synthetic crude oil.

There has thus been outlined, rather broadly, various features of the invention so that the detailed description thereof that follows may be better understood, and so that the present contribution to the art may be better appreciated. Other features of the present invention will become clearer from the following detailed description of the invention, taken with the accompanying claims, or may be learned by the practice of the invention.

### BRIEF DESCRIPTION OF THE DRAWINGS

FIG. 1 is a schematic drawing of an oil sand mining operation on the surface involving a mine face, an earth mover or shovel, a crusher, oil sand and crushed oil sand transportation, slurry production and slurry transportation in accordance with one embodiment of the present invention.

FIG. 2 is a schematic drawing of an oil sand separation operation involving a variety of pumps and pipes, two hydrocyclones in series, an oleophilic belt separator and a tailings pond for dewatering of tailings in accordance with one embodiment of the present invention.

FIG. 3 is a perspective drawing of the inside of the oleophilic belt separator of FIG. 2.

FIG. 4 is a perspective drawing of the inside of another oleophilic belt separator in accordance with one embodiment of the present invention.

FIG. 5a is a side view and FIG. 5b is a top view of an endless cable belt used for dewatering oil sand tailings as an alternative to an oil sand tailings pond in accordance with one embodiment of the present invention.

FIG. 6 is a schematic drawing of a system or process for removing hydrophilic particulates from bitumen product in accordance with another embodiment of the present invention.

FIG. 7 is a schematic drawing of a system for thoroughly mixing a paraffinic hydrocarbon with a bitumen product to remove water, solids and heavy asphaltenes to yield a bitumen suitable for long distance pipelining or upgrading to synthetic crude oil in accordance with one embodiment of the present invention.

It will be understood that the above figures are merely for illustrative purposes in furthering an understanding of the invention. Further, the figures are not drawn to scale, thus dimensions and other aspects may, and generally are, exaggerated or changed to make illustrations thereof clearer. Therefore, departure can be made from the specific dimensions and aspects shown in the figures in order to produce the separation system using endless cables of the present invention.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It must be noted that, as used in this specification and the appended claims, the singular forms “a,” “an,” and “the” include plural referents unless the context clearly dictates otherwise. Thus, for example, reference to “a splice” includes one or more of such splices, reference to “an endless cable” includes reference to one or more of such endless cables, and reference to “the material” includes reference to one or more of such materials.

Definitions

In describing and claiming the present invention, the following terminology will be used in accordance with the definitions set forth below.

As used herein, the term “endless cable” refers to a cable having no beginning or end, but rather the beginning merges into an end and vice-versa, to create an endless or continuous cable. The endless cable can be, e.g., a wire rope, a plastic rope, a single wire, compound filament (e.g. sea-island) or a monofilament which is spliced together to form a continuous loop, e.g. by long-splicing.

As used herein, “conditioning” in reference to mined oil sand is consistent with conventional usage and refers to mixing a mined oil sand with water, air and caustic soda to produce a warm or hot slurry of oversize material, coarse sand, silt, clay and aerated bitumen suitable for recovering bitumen froth from said slurry by means of froth flotation. Such mixing can be done in a conditioning drum or tumbler or, alternatively, the mixing can be done as it enters into a slurry pipeline and/or while in transport in the slurry pipeline. Conditioning aerates the bitumen for subsequent recovery in separation vessels. Likewise, referring to a composition as “conditioned” indicates that the composition has been subjected to such a conditioning process.

As used herein, “bitumen” refers to a viscous hydrocarbon that may include maltenes and asphaltenes that is found in oil sands ore interstitially between sand grains. In a typical oil sands plant, there are many different streams that may contain bitumen.

“Agglomeration drum” refers to a revolving drum containing oleophilic surfaces that is used to increase the particle size of bitumen in oil sand slurries prior to separation. Bitumen particles flowing through said drum come in contact with the oleophilic surfaces and adhere thereto to form a layer of bitumen of increasing thickness until the layer becomes so large that shear from the flowing slurry and from the revolution of the drum causes a portion of the bitumen layer to slough off, resulting in bitumen particles that are much larger than the original bitumen particles of the slurry.

As used herein, “fluid” refers to flowable matter. Fluids, as used in the present invention typically include a liquid, gas, and/or flowable particulate solids, and may optionally further include amounts of solids and/or gases dispersed therein. As such, fluid specifically includes slurries (liquid with solid particulate), flowable dry solids, aerated liquids, gases, and combinations of two or more fluids. In describing certain embodiments, the term slurry and fluid may be used interchangeably, unless explicitly stated to the contrary.

The term, “central location” refers to a location that is not at the periphery. In the case of a pipe, a central location is a location that is neither at the beginning of the pipe nor the end point of the pipe and is sufficiently remote from either end to achieve a desired effect, e.g. washing, disruption of agglomerated materials, etc.

As used herein, “velocity” is used consistent with a physics-based definition; specifically, velocity is speed having a particular direction. As such, the magnitude of velocity is speed. Velocity further includes a direction. When the velocity component is said to alter, that indicates that the bulk directional vector of velocity acting on an object in the fluid stream (liquid particle, solid particle, etc.) is not constant. Spiraling or helical flow-patterns are specifically defined to have substantially constant or gradually changing bulk directional velocity.

The “isoelectric point” (pI) is defined as the pH at which a particular molecule or surface carries no net electrical charge and thus is not encouraged to disperse from other molecules or surfaces in an aqueous medium. With respect to oil sand separation, isoelectric separation of oil sand or oil sand slurry is separation in which the pH is such that, on average, the clay particles in aqueous slurry produced from the oil sand are at or close to or substantially at the isoelectric point. Since oil sands vary in composition from location to location and may also contain a variety of clay types at each location, and each clay type has its own isoelectric point, isoelectric separation of an oil sand slurry would by necessity be defined as separation taking place at a suitable average isoelectric point such as to minimize dispersion of the clay particles before and after separation and to minimize the trapping of water in gel like microscopic clay card house structures in tailings effluents upon settling.

The term, “multiple wrap endless cable” as used in reference to separations processing refers to an endless cable that is wrapped around two or more drums and/or rollers a multitude of times to form an endless belt having spaced cables. Movement of the endless cable belt can be facilitated by at least two guide rollers or guides that prevent said cable from rolling off an edge of the drum and guide the cable back to the opposite end of the same or other drum. The spacing in the endless belt is formed by the slits or gaps between sequential wraps. The endless cable can be a wire rope, a plastic rope, a single wire, compound filament (e.g. sea-island) or a monofilament which is spliced together to form a continuous loop, e.g. by long splicing. As a general guideline, the diameter of the endless cable can be as large as 3 cm and as small as 0.001 cm, although other sizes might be suitable for some applications. An oleophilic endless cable belt is a cable belt made from a material that is oleophilic under the conditions at which it operates.

As used herein, “single wrap endless cable” refers to an endless cable which is wrapped around two or more cylindrical members in a single pass, i.e. contacting each roller or drum only once.

The term “cylindrical” indicates a generally elongated shape having a circular cross-section. Therefore, cylindrical includes cylinders, conical shapes, and combinations thereof. The elongated shape has a length referred herein also as a depth as calculated from one of two points - the open vessel inlet, or the defined top or side wall nearest the open vessel inlet.

As used herein, “digested slurry” refers to a slurry from which bitumen particles have been at least partially (and in many cases primarily) disengaged from sand grains of the original oil sand ore. Oil sand ore comprises mainly sand grains in which the voids between the sand grains are filled with bitumen. An oil sand slurry may be produced by thoroughly mixing the oil sand ore with water in such a manner that the sand grains and the bitumen form discrete particulates individually dispersed in an aqueous medium. Thus, in such a slurry most of the bitumen particles have disengaged from and are separate from the sand grains.

As used herein, “recovery yield” refers to the percentage of material removed from an original mixture or composition. Therefore, in a simplified example, a 100 kg mixture containing 45 kg of water and 40 kg of bitumen where 38 kg of bitumen out of the 40 kg is removed would be a 95% recovery yield.

As used herein, the term “confined” refers to a state of substantial enclosure. A path of fluid may be confined if the path is, e.g., walled or blocked on a plurality of sides, such that there is an inlet and an outlet and direction of the flow is directed by the shape and direction of the confining material.

As used herein, “retained on” refers to association primarily via simple mechanical forces, e.g. a particle lying on a gap between two or more cables. In contrast, the term “retained by” refers to association primarily via active adherence of one item to another, e.g. retaining of bitumen by an oleophilic cable. In some cases, a material may be both retained on and retained by one or more cables.

The term “roller” indicates a revolvable cylindrical member or drum, and such terms are used interchangeably herein.

As used herein, “wrapped” or “wrap” in relation to a cable wrapping around an object indicates an extended amount of contact. Wrapping does not necessarily indicate full or near-full encompassing of the object.

The term “metallic” refers to both metals and metalloids. Metals include those compounds typically considered metals found within the transition metals, alkali and alkali earth metals. Examples of metals are Ag, Au, Cu, Al, and Fe. Metalloids include specifically Si, B, Ge, Sb, As, and Te. Metallic materials also include alloys or mixtures that include metallic materials. Such alloys or mixtures may further include additional additives.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, a plurality of components may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, volumes, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 inch to about 5 inches” should be interpreted to include not only the explicitly recited values of about 1 inch to about 5 inches, but also include individual values and sub-ranges within the indicated range. Thus, included in this numerical range are individual values such as 2, 3, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

### EMBODIMENTS OF THE INVENTION

It has been found that effective oil sand slurry separation can be achieved by passing the slurry to and through a revolvable oleophilic device having gaps or apertures. Such an oleophilic device can take the form of an apertured drum, an apertured belt, a mesh belt or an endless cable that is formed into an oleophilic belt by wrapping the endless cable a multitude of times over two or more drums or rollers as described in the co-pending Endless Cable Application.

Separating oil sand slurry using such an oleophilic device is not a flotation operation but represents a screening operation in which water and hydrophilic solids pass through the gaps and/or apertures of the device whilst bitumen and oleophilic solids adhering to the bitumen are captured by and retained on the surfaces of the revolvable oleophilic device for subsequent recovery. Unlike the commercial Clark flotation process, this method of separation does not require the addition of a caustic process aid, does not require air bubbles to which bitumen can adhere to achieve flotation and does not require dispersion of the fines of the slurry. The bitumen product is not a froth but a viscous flowable liquid no or substantially no air and the resulting oil sands tailings product is not toxic and neither is the resulting tailings water.

The separation is carried out at or near the isoelectric point of the fines of the oil sand slurry and, under those conditions, the resulting tailings generally do not form microscopic card house structures. Therefore, tailing produced by the processes and systems of the present invention can be readily recycled within the recovery operation or released to the environment with minimal treatment.

Separation of oil sand slurries by means of an oleophilic endless belt formed from one or more endless cables has certain advantages and certain disadvantages. Abrasion of the equipment by sharp sand grains or damage from gravel or rocks is one of the disadvantages. For that reason oil sand slurry can be de-sanded before it comes in contact with the oleophilic wall device. A suitable hydrocyclone for such de-sanding is disclosed in the co-pending Hydrocyclone Application.

Oil sand can be mined, crushed, mixed with water and pumped into one or more pipes which are configured to form a digested slurry after required screening to remove oversize material to prevent conduit blockage. The digestion pipe transport system can include straight pipe, serpentine conduits, or other suitable system which allows for digestion of the slurry, often without introduction of a surfactant, caustic soda, or other processing fluids other than water. For example, slurry can be at least partly digested in a straight pipe under turbulent flow if the pipe is longer than 1 kilometer and if the slurry temperature is high enough, e.g. from about 30° C. to about 80° C. Alternatively, or in addition, serpentine conduits can be included along the digestion pipe transport system. Suitable serpentine or sinusoidal conduits can include a plurality of angles which create a shear mixing and turbulent environment within the slurry flow. Such serpentine conduits are described in more detail in the co-pending Sinusoidal Mixing Application. Optionally, a plurality of pipes can be used in parallel in order to provide increased capacity, as back-up pipes, and/or to reduce required pump sizes.

The digested slurry is passed through one or more hydrocyclones to separate the slurry into an aqueous underflow containing coarse solids and a de-sanded overflow containing an aqueous mixture of dispersed bitumen and fine solids. The overflow is passed to and through an oleophilic revolving device which in one embodiment can include one or more endless cables wrapped a multitude of times around two or more rollers. An agglomerator may be used to agglomerate the bitumen particles to make them larger prior to passage to the oleophilic members (e.g. endless cables, apertured wall, etc.) of the device. At the oleophilic wall, water and fine solids pass through the gaps or apertures and bitumen adheres to the oleophilic wall for subsequent removal as a liquid bitumen product containing little or no air.

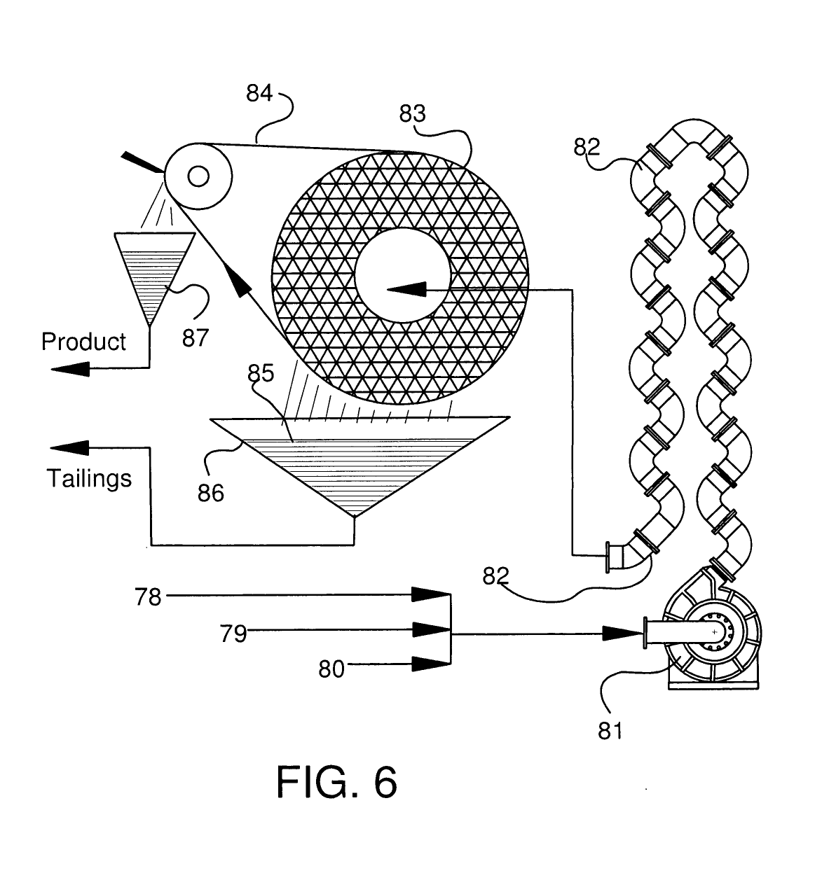

Bitumen product, a viscous liquid, removed from the oleophilic wall contains entrained water and hydrophilic and oleophilic solids. Before such bitumen can be pipelined over extended distances or upgraded to synthetic crude oil it should usually be cleaned to remove water and solids. One method of removing hydrophilic solids from viscous liquid bitumen is illustrated in FIG. 6 (discussed in more detail below) where continuous phase bitumen, continuous phase water and a chemical are mixed at high speed in a serpentine conduit 82 to disperse this bitumen in water and transfer entrained hydrophilic particulates from the bitumen phase to the continuous water phase. While it does not remove oleophilic solids, it may reduce the cost of subsequent bitumen clean up processing.

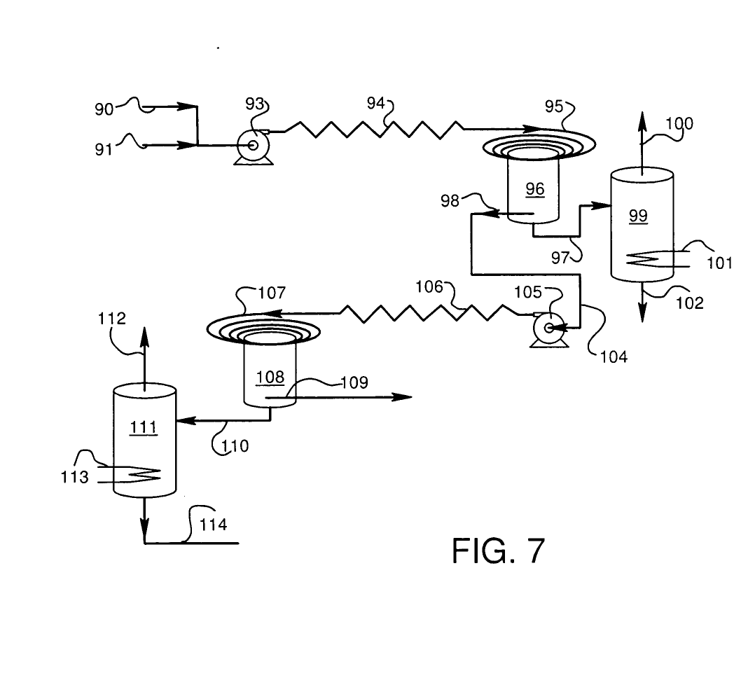

One method of cleaning up bitumen is shown in FIG. 7 (discussed in more detail below) where bitumen product, before or after hydrophilic solids removal, is mixed with a warm or cool paraffinic hydrocarbon to produce a diluted bitumen product that is suitable for long distance pipeline transport or for upgrading to synthetic crude oil after the paraffinic hydrocarbon is optionally removed, e.g. by evaporation, and may be reused in the process.

General

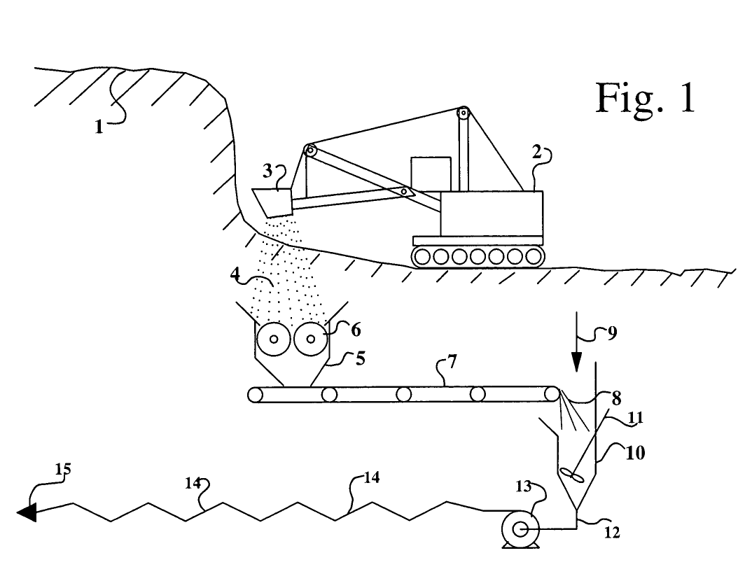

FIG. 1 is a schematic drawing of a mining operation on the surface based on the instant invention. This system or process, or modifications of it, may be used on the surface of an oil sands lease. Alternatively, at least a portion of the process may be carried out in a mineshaft or in a mine chamber below the surface and below overburden. Removing overburden from deep oil sand deposits can be very expensive and it may be expected that in due time economical methods will be found to mine oil sands from under the overburden without having to remove this overburden. About 10 to 20 percent of the Alberta oil sands are close enough to the surface to be surface mined economically. The remaining 80 to 90 percent are too deep for economical surface mining. Some of the deep Alberta oil sand deposits are higher in bitumen content than the oil sands that are currently mined at the surface. Currently bitumen is recovered with steam from deep Alberta oil sand deposits by the SAGD process using two apertured pipes below each other. The upper pipe delivers steam to the deposit and the bottom pipe collects bitumen made fluid by the steam. It has been reported by one of the major oil sand operators that the SAGD process produces 95 kilograms of carbon dioxide whilst the current commercial Clark process produces 45 kilograms of carbon dioxide per barrel of bitumen produced. This illustrates that producing bitumen from deep deposits with steam requires 2.1 times more energy than producing bitumen by mining and processing oil sands at the surface with the energy-inefficient Clark process, including the energy needed to remove a significant amount of overburden at the surface. It may be expected that mining of the oil sands below the surface in due time will become an economic alternative, especially in view of the huge size of the deeply buried Alberta oil sand resource. To recover a barrel of bitumen with steam under the SAGD process requires a huge amount of energy and several barrels of good quality water.

Referring back to FIG. 1, an above surface mining operation is shown. A mechanical shovel 2 or other mining equipment recovers or mines oil sand from a mine face 1, from which overburden has been removed, with the use of a bucket 3 or other mining device. The mined oil sand 4 is transported by gravity, conveyor, an earth moving vehicle or other suitable mechanism to a crusher 5. Typically suitable crushers can incorporate, for example, crushing rolls 6 to break up the mined oil sand, rocks and lumps of clay into particulates that are small enough to subsequently flow in water in a pipeline without blockage. After crushing, the oil sand can be transported by a transporting device 7 to a container 10. The transporting device can be a conveyor or other suitable mechanism. Water 9 can be added to the crushed and transported oil sand 8 and is blended with a mixer 11 to form an oil sand in water mixture 12 which is flowable. The mixture can be pumped using a pump 13 into a serpentine conduit 14 where the mixture can be digested into a suitable oil sand slurry flowing in the direction shown by the arrow 15. In the digesting process bitumen is disengaged from the sand grains. A detailed description of the serpentine conduit is given in the co-pending Sinusoidal Mixing Application. Before the slurry is introduced into the serpentine conduit it may be optionally screened to remove oversize rocks or lumps that could block, damage or interfere with digesting processes in the conduit or in subsequent de-sanding equipment. The digested slurry may also be screened after it leaves the serpentine conduit, if necessary, to prevent damage to the de-sanding equipment.

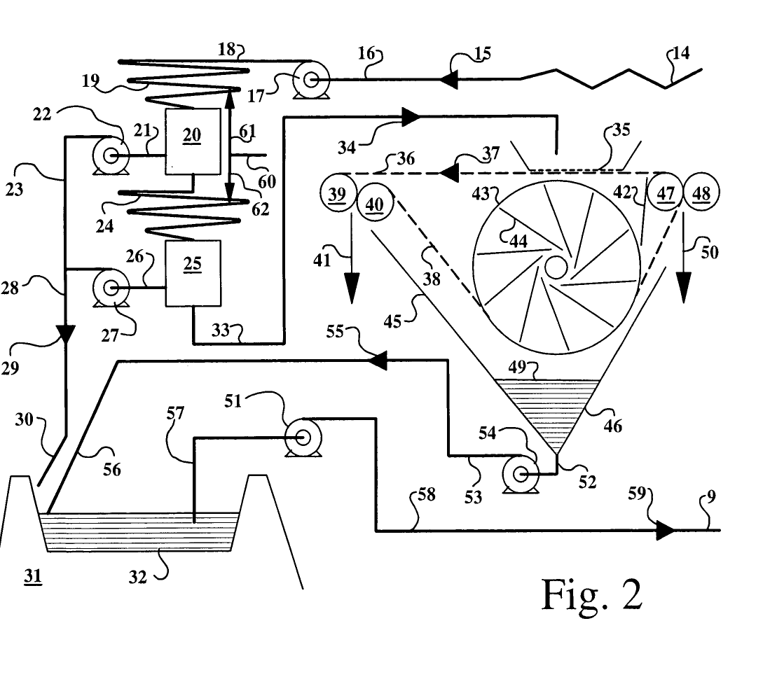

FIG. 2 is a schematic drawing of an oil sand separation system or process that separates oil sand slurry that has been digested by a serpentine conduit 14 described with FIG. 1. Digested slurry 18 flows under pressure from the serpentine conduit or from a straight pipe 16 attached to the serpentine conduit 14 or is re-pressurized with a pump 17 to flow into a hydrocyclone. The hydrocyclone can include a helical confined path 19 of a first of two hydrocyclones. More specifics and alternative designs for suitable hydrocyclones are described in the co-pending Hydrocyclone Application. Underflow 21 leaves an open vessel 20 of the first hydrocyclone and flows under pressure or is pumped with a pump 22 through pipes 23, 28 and 30 to a tailings pond where it can be deposited as coarse sand on the beach of the tailings pond 31. The arrow 29 shows the direction of flow towards the tailings pond.

Wash water 60 is optionally added through a pipe 61 and injected into the confined helical path 19 to encourage bitumen to report to the overflow 24 of the open vessel 20. This overflow from the first hydrocyclone can flow into a second hydrocyclone situated in FIG. 2 below the first hydrocyclone. As with the first hydrocyclone, wash water 60 can be injected through a pipe 62 into the confined helical path of the second hydrocyclone to encourage bitumen to report to the overflow 33 of the open vessel 25 of the second hydrocyclone. Underflow 26 leaves the open vessel 25 of the second hydrocyclone and flows under pressure or is pumped with a pump 27 to pipe 28 where it joins the underflow 21 from the first hydrocyclone and flows though pipe 30 to the beach of the tailings pond 31.

The overflow 33 from the open vessel 25 of the second hydrocyclone flows in the direction shown by the arrow 34 into a distribution device 35. The distribution device can be any device such as, but not limited to, a screen, vibrator, or the like, that distributes the thus de-sanded slurry onto a top flight 36 of an oleophilic endless belt formed from multiple wraps of one or more endless cables. The arrow 37 shows the direction of movement of the belt. Water and hydrophilic solids pass through gaps between adjacent wraps of the cable on the top flight 36 and bitumen is captured by the top flight, e.g. by adherence to the cable. The top flight passes between two squeeze rollers 39 and 40 to removed captured bitumen, which also contains some solids and water, although other mechanisms could be used to remove bitumen from the cables. The squeezed off bitumen 41 is collected in a pipe or vessel (not shown) as a primary bitumen product.

Water and hydrophilic solids passing through the gaps of the top flight fall onto and into an agglomerator 43 which contains oleophilic baffles 44. A deflecting baffle 42 prevents water and solids from contacting a bitumen recovery or squeeze roller 47. Residual bitumen not recovered by the top flight 36 flow through the top flight gaps with water and hydrophilic solids into the agglomerator 43 where bitumen comes in contact with oleophilic baffles 44. Bitumen adheres to these baffles in increasing thickness until shear from the flowing water and hydrophilic particulates strip bitumen from these baffles 44. The resulting mixture of water, solids and enlarged bitumen particulates leaves the agglomerator 43 and flows to the bottom flight 38 where most of the agglomerated bitumen is captured and remaining water and solids flow into a vessel 46 to become the de-sanded tailings 49. Vessel walls or baffles 45 collect spillage or drippings and direct these to the de-sanded tailings 49. Adhering bitumen is removed from the bottom flight 38 using squeeze rollers 47 and 48 to remove captured bitumen. Alternatively, adhering bitumen can be removed by any suitable approach such as, but not limited to, combs, heating, or the like. The squeezed off bitumen 50 is collected in a pipe or vessel (not shown) as a secondary bitumen product. Both bitumen products 41 and 50 can be further processed separately or in combination. Various other suitable methods for separating bitumen from an aqueous mixture are described in the co-pending Endless Cable application.

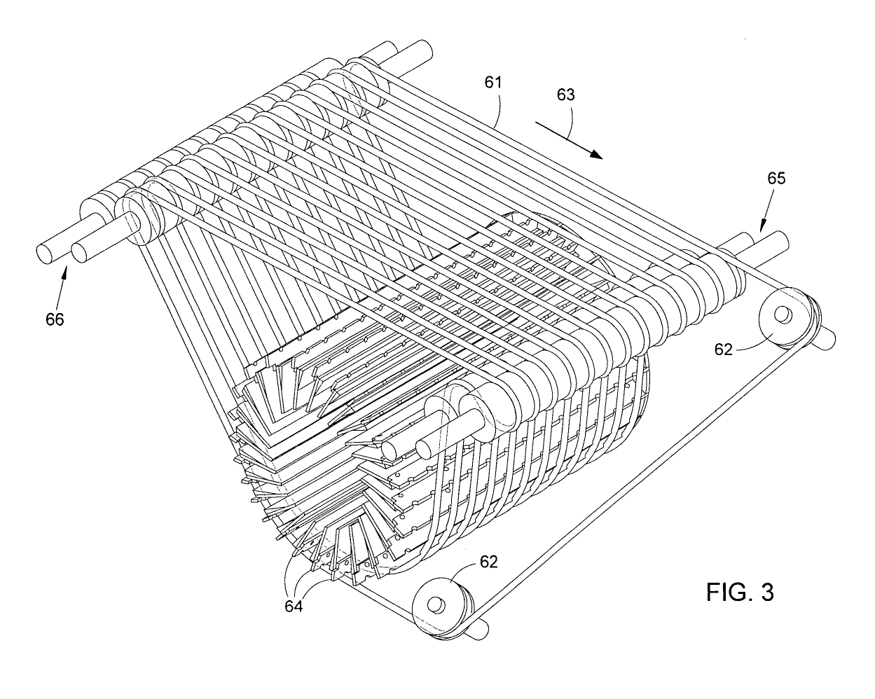

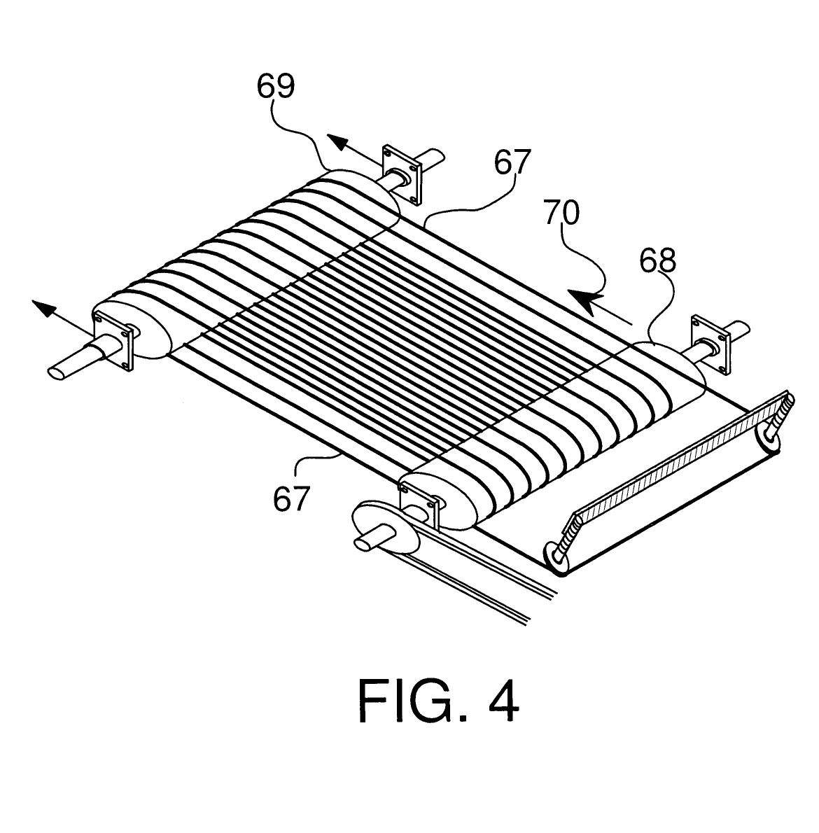

Referring now to FIG. 3, a suitable agglomerator 64, the endless cable 61 and the squeeze rollers 65 and 66 of FIG. 2 are shown. In this case the direction 63 of the belt is opposite to that of FIG. 2, such that squeeze rollers 65 would remove bitumen from the top flight and squeeze rollers 66 would remove bitumen from the bottom flight. Only one endless cable 61 is shown along with guide rollers 62 to prevent the endless cable from running off the rollers. Several endless cables may be optionally used. FIG. 4 is another optional configuration for a revolvable oleophilic endless cable system. It is a simplified perspective drawing of an endless cable 67 formed into an endless belt. In this case, one roller 68 is driven and one roller is the tension roller 69. The arrow shows the direction of movement 70 but this direction can be reversed without changing the operation of the device.

Referring again to FIG. 2, the de-sanded tailings 49 flow through a pipe 52 to a pump 54 and are pumped as de-sanded tailings product 53 in the direction shown by the arrow 55 through a pipe 56 to the tailings pond to become the settling desanded tailings 32. Clear water rising to the top of the settling tailings 32 of the pond is conveyed by a pipe 57 to a pump 51 which pumps it through a pipeline 58 in the direction shown by the arrow 59 to become recycle water for reuse in the process described with FIG. 1. This recycle water can be used as inlet water 9 or combined with another water source. The tailings pond here described is a short-term working tailings pond from which process water can be reused within about two or three months except in winter when frost may prevent the use of pond surface water. This is in contrast with the long term tailings ponds of the commercial Clark process, which are very much larger, and from which recycle water can be reused in the process after settling for many years or decades. As a result, the volume of a tailings pond in accordance with the present invention can be much smaller than one tenth of the volume of a long term tailings pond required for the conventional Clark process. For example, one tailings pond of a current commercial mined oil sands plant has a circumference of 20 kilometers and may be more than 100 meters deep in the middle.

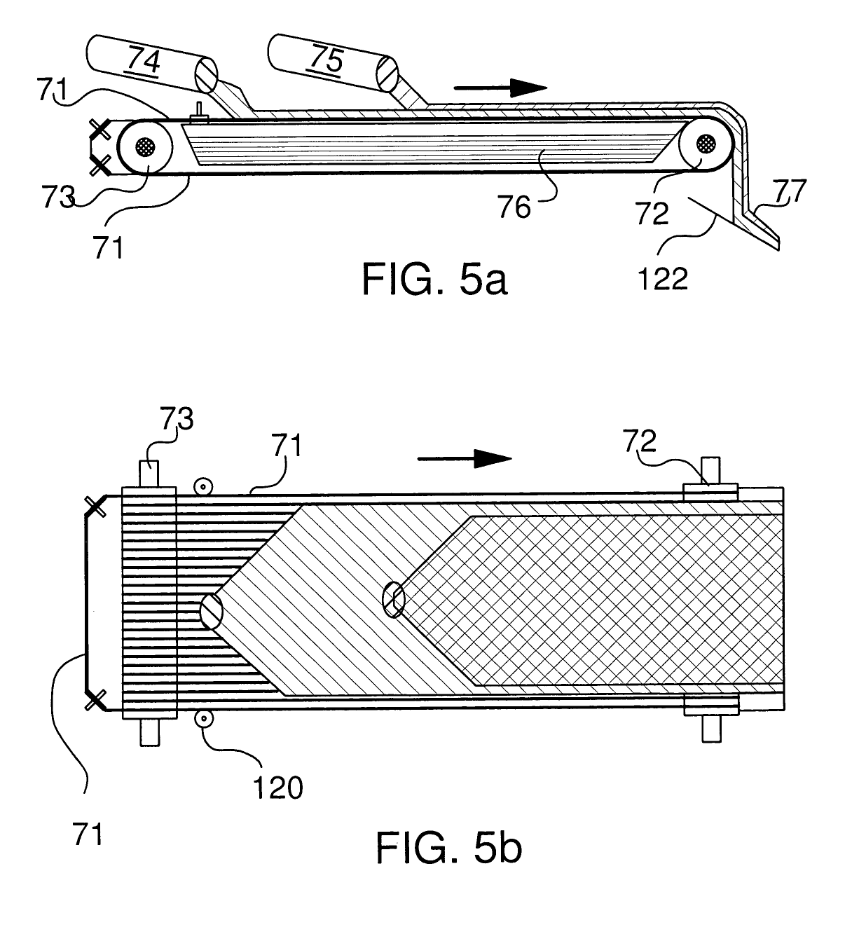

When a tailings pond is not desired, a mechanical process may be used to dewater the tailings. Such mechanical processes are often more expensive and less effective but will require less room than a tailings pond. One dewatering option involves the use of a revolving dewatering filter described with FIGS. 5a and 5b. Shown in FIG. 5a is the side view of a revolving filter and in FIG. 5b a top view of the same filter. For processing high grade, low fines oil sand ore the filter bed of FIG. 5a and 5b may be used instead of a settling pond. Underflow 74 containing coarse solids and water can be deposited onto a moving filter which includes a driven roller 72, a tension roller 73, several guide rollers 120, and an endless cable 71 that is wrapped a multitude of times around the rollers 72 and 73 to form a filter belt. The wraps of this filter bed are touching, or are so close together that generally only water will pass through the spaces between the cable wraps while retaining the coarse solids on top of the wraps. The underflow 74 is spread over nearly the full width of the filter belt by a spreading mechanism (not shown) to form a dewatered filter bed of coarse solids. De-sanded tailings 75 containing water and fine solids can be deposited on top of the bed of dewatering or dewatered underflow. The de-sanded tailings 75 are similarly spread over nearly the full width of the dewatering or dewatered underflow 74 layer by a spreading mechanism (not shown). As a result of the described deposition, the moving bed of underflow serves as a filtering aid for the moving bed of de-sanded tailings resting on top of the bed of underflow, preventing the fine particulates of the overflow from passing through the slits between the cable wraps. The bed of dewatering solids moves to the right of FIG. 5a and 5b as shown by the arrow and revolves off the bed along chute 122 to the right as a dewatered tailings 77 for disposal, for example in the mined out portion of the oil sands mine. Water that has passed through the slits between the cable wraps of the endless cable 71 can be collected in a receiver 76 and returned to the oil sands separation process for reuse. Highly abrasion resistant and strong cables may be used for this filter bed and wash water or compressed air may be used to keep the bottom flight and the left roller 73 clean of solids. While only two rollers are shown here, a series of support rollers may be mounted below the top flight to prevent excessive sagging or undesirable surface contours on the upper surface of the filter.

In contrast, the underflow of FIG. 2, containing water, rocks; gravel coarse sand and some residual bitumen was shown to flow into a tailings pond for dewatering and for building dykes. Also, de-sanded tailings containing water, finer solids and some residual bitumen were shown in FIG. 2 to flow into a tailings pond for settling and to release water for reuse in the process. A tailings pond can be used to recover water for reuse in the process. As was explained above, separation in the process or system of the instant invention can be done at isoelectric conditions and a caustic process aid is not used. As a result, settling of solids in the tailings pond of FIG. 2 is rapid and process water may be returned to the process after about two or three months of solids settling for most oil sands unless freezing temperatures prevent access to the released pond water.

Tailings Pond Bitumen Recovery

In yet another embodiment of the present invention, the endless cable device can be used to recover bitumen from conventional caustic tailings found in tailings ponds associated with the Clark process or other similar processes. Current commercial developers of the Clark process see a tailings pond as a means for storing toxic tailings and recovering water for reuse in the commercial process but generally do not use a pond as part of the process for recovering bitumen. As a result, the current commercial plants go to great lengths and expense recover bitumen from the warm tailings before they flow into the ponds and loose their elevated temperatures. However, in accordance with the present invention, a large amount of additional bitumen may be recovered as such a tailings pond is incorporated into a bitumen recovery process utilizing the endless cable devices of the present invention. At current commercial tailings ponds, sand and silt settle out of the tailings and water floats to the top, leaving a sludge containing bitumen, clay fines and water present in a bitumen-rich middlings portion of the pond (e.g. below the water rich layer and above the sand and silt layer). The percent bitumen content of this sludge can be an order of magnitude greater than the bitumen content of the tailings flowing into the pond. In some cases, on a dry basis percentage, sludge may contain as much bitumen as mined oil sand ore. As long as the ponds are not abandoned, this bitumen is not lost but collects in the ponds and may be recovered by oleophilic devices described in this or in the Endless Cable application. Such separation may be carried out at very low temperatures, even approaching zero degrees centigrade when centrifugal tailings (or tailings from other types of hydrocarbon bitumen clean up) are blended with primary and secondary tailings flowing into the pond thereby reducing the viscosity of bitumen of primary and secondary tailings by residual solvent contained in the centrifugal tailings. Without such blending, the separation of sludge from primary and secondary tailings may be carried out by oleophilic means around 10° C. to 20° C. The bitumen rich sludge can be collected using a suitable mechanism, such as but not limited to, pumping with an intake set at the appropriate depth. The collected sludge can then be directed to the endless cable as either the sole feed (optionally mixed with water or other additives to control flowability) or in combination with a crushed sands slurry or other materials as discussed previously.

When a tailings pond becomes part of the bitumen recovery process of a commercial oil sands plant, and oleophilic means can be used to recover this bitumen. Allowing bitumen to accumulate and concentrate in tailings ponds and then recovering this bitumen at a later date can effectively increase overall annual commercial plant bitumen recovery after the commercial plant has been in operation for some time. Since caustic process aid is used in the current commercial plants, the debitumenized sludge left after recovering bitumen from a current commercial tailings pond (e.g. using the Clark process or its equivalent) remains toxic.

Removal of Hydrophilic Solids

Bitumen product recovered from oil sand or from pond sludge by the present invention normally is a continuous phase viscous liquid bitumen that contains dispersed water, fine grained hydrophilic solids and fine grained oleophilic solids but very little or no air. It is liquid bitumen and not an aerated froth. The oleophilic solids generally adhere tightly to bitumen but water and hydrophilic solids generally are trapped as dispersed water droplets and water wet solids in the bitumen product. A large portion of these hydrophilic solids may be removed by washing this bitumen product with water.

One such water washing method is shown in FIG. 6. Bitumen product 78, water 79 and a detergent 80 can be fed into the inlet of a pump 81 to force this mixture at high speed through a serpentine conduit 82. The detergent is suitably selected to encourage bitumen to be dispersed in water while preventing the formation of tight or hard to break bitumen in water emulsions. The amount of detergent required normally is less than one tenth of a percent of the water used. The desired ratio of water to bitumen product can vary from one half to five depending on the concentration and particle size of the hydrophilic solids in the bitumen product The serpentine conduit serves to thoroughly mix and disperse this mixture of components. As a result of passing through this serpentine conduit the continuous phase bitumen product is broken up and converted into oil phase droplets dispersed in a continuous aqueous phase. Hydrophilic solids held in the original continuous oil phase bitumen are released and transfer to the now continuous aqueous phase. The resulting aqueous mixture of water, dispersed bitumen droplets and hydrophilic solids is fed into an agglomerator 83 surrounded by an endless cable belt 84 having multiple wraps. The agglomerator, for example, may be filled with oleophilic tower packings or tumbling oleophilic balls. In the agglomerator 83 dispersed bitumen droplets come in contact with and adhere to the oleophilic surfaces of the packings or balls until these slough off in the form of enlarged bitumen droplets and are captured by the endless cable belt 84 and subsequently removed to become a continuous phase processed bitumen product 87. A tailings receiver 86 collects the hydrophilic solids and water 85 of the separation.

Alternately a different system, such as illustrated in FIG. 2 and 3 or disclosed in the co-pending Endless Cable application may be used instead to separate the mixture. While a large portion of the hydrophilic solids may be removed from bitumen products by these methods, residual water and oleophilic solids remain the impurities that must be removed from the bitumen before it is suitable for long distance pipeline transport or for upgrading to synthetic crude oil. By removing a portion of the bitumen solids, the process of FIG. 6 or similar processes using an oleophilic wall may serve to simplify or to reduce the cost of subsequent bitumen clean up.

Heavy Minerals

Precious metals and non-precious heavy minerals have an affinity for bitumen and are or become oleophilic upon contact with bitumen. When bitumen product contains heavy minerals such as gold and silver and ores of titanium and zirconium, it can be advantageous to first beneficiate these oleophilic heavy minerals by the method of FIG. 6 by reducing its hydrophilic minerals content before this bitumen is further cleaned up during which most water and most minerals are removed. Prior removal of the bulk of hydrophilic minerals from bitumen may simplify subsequent removal of water and minerals from bitumen. This staged removal of solids serves to concentrate or beneficiate oleophilic minerals in the final minerals product of bitumen clean up.

Geologically it is generally accepted that in times past oil migrated into porous sediments of sand and silt to eventually form oil sand deposits after such porous sediments had been established. Precious and other minerals often are found in many sediments along riverbanks as the result of minerals weathering upstream of such rivers. When oil sands were formed in riverbed sites due to such oil migration, bitumen recovered from such sites will most likely contain precious and other heavy minerals due to the oleophilic attraction of such minerals for bitumen. This may explain why significant concentrations of precious minerals only are found in oil sands in a few locations. The Alberta oil sands contain a greater abundance of titanium and zirconium ores in the form of small particulates, which are widely distributed through the deposit. When bitumen is separated from the Alberta oil sands it nearly always contains titanium and zirconium ore particulates due to the affinity of these heavy minerals for bitumen.

It is well known in the oil sands industry that heavy minerals, including ilmenite, rutile and zircon adhere to bitumen froth in aqueous oil sand separation methods, such as the Clark process, and many authors in this industry have concluded that essentially all the heavy minerals found in mined oil sands end up in the centrifugal tailings of commercial oil sands plants.

However, the present inventor has found that heavy minerals also accumulate in the tailings ponds from primary and secondary tailings of at least one of the current commercial mined oil sands plants. This was determined from the large amount of heavy minerals in bitumen produced from the sludge of a tailings pond that primarily received primary and secondary tailings and rarely any centrifugal tailings from the commercial plant. These results were obtained from a pilot plant operated for about 9 months with tailings pond sludge being separated with an apertured oleophilic wall at a rate of 1 tonne of sludge per hour. Sludge had been formed by settling in this pond after sand and silt dropped out of the primary and secondary tailings and water rose to the top of the pond. By dropping out tailings sand and water, this tailings pond in effect served to concentrate bitumen in tailings pond sludge in the form of dispersed bitumen and in the form of bitumen mats. Bitumen and bitumen mats are found in many oil sand tailings ponds. The sludge from this pond contained up to 10 weight percent bitumen and, after water washing, the bitumen product from the pilot plant averaged about 8 weight percent heavy minerals. The heavy minerals recovered from this bitumen product were very high in rutile, a preferred ore of titanium. The composition of bitumen product from his pilot plant did not vary much from sludge collected and processed at various times from various locations within the pond.

This abundance of heavy minerals in pond sludge from primary and secondary tailings was a surprising discovery. Without being bound by theory this abundance may be explained by considering the probable behavior of bitumen droplets rising in a flotation vessel, when heavy minerals weigh down these droplets. In a commercial froth flotation plant tiny particles of mineral adhere to and are part of the bitumen droplets that rise in the separation vessels aided by air bubbles. Bitumen droplets that contain a small amount of mineral matter, but are attached to air bubbles, will float to the top fast enough to be skimmed off from the separation vessels as froth. Bitumen droplets that are loaded more heavily, especially when air is not abundant in the slurry, will rise slower in these vessels and may never reach the top before this bitumen leaves with the tailings. This discovery that this tailings pond sludge was high in heavy minerals content may explain why the commercial Clark process can at times have high bitumen losses to the tailings. These losses may be the result of minerals, and especially heavy minerals, loading down some bitumen droplets sufficiently to prevent their desired flotation, especially when there is a shortage of flotation air. By the same token, any particulate matter, heavy or not so heavy, may reduce or prevent bitumen flotation if this particulate matter adheres to bitumen droplets or flecks in sufficient amounts.

Unlike froth flotation, when an oleophilic wall device as in the present invention, for example, an oleophilic endless cable belt, is used to process oil sand slurries, the density of bitumen droplets is only a small consideration in the separation process. A large amount of heavy minerals can be collected along with the bitumen product without being concerned about bitumen density. Bitumen recovery is very high because both light bitumen and heavy bitumen are recovered without being influenced to a significant degree by minerals content. As explained with FIG. 6, washing the recovered bitumen with water removes a large percentage of hydrophilic minerals that do not normally adhere to bitumen but are captured with water droplets as a dispersed phase in the bitumen product. Suitable water washing of bitumen product also may strip oil films from the surfaces of normally hydrophilic particles and convert these from being oleophilic to being hydrophilic sufficiently to cause more hydrophilic minerals to report to the aqueous tailings of water washing. Hydrophilic minerals may be at least as abundant as oleophilic minerals in the bitumen product of oleophilic screening devices separating oil sands. If heavy minerals are to be recovered from this bitumen product, it can be advantageous from the perspective of ore beneficiation, to first remove hydrophilic minerals from this bitumen product before water and remaining minerals are removed by bitumen clean up in preparation for bitumen upgrading or for long distance bitumen pipeline transport. Thus, water washing of bitumen tends to remove hydrophilic solids and tends to concentrate the heavy minerals that remain in the bitumen. When these remaining minerals are subsequently removed from water washed bitumen by dilution centrifuging or by the use of paraffinic hydrocarbons, the percent of heavy minerals in the removed minerals is greater than what is found in minerals removed from bitumen products that are not washed with water.

Another benefit of washing a bitumen product with water is that it may reduce corrosion of subsequent bitumen clean up or transportation equipment by removing chlorides or other undersirable components. Since the present invention does not use caustic soda the water dispersed in the bitumen product may contain chlorides and other salts or acids that could damage such equipment. Washing bitumen with clean water will reduce the amount of such substances in the bitumen product. Reagents to neutralize such substances may even be added to the wash water if desired.

Bitumen Clean Up

Bitumen product from an oleophilic device, such as bitumen product from an oleophilic endless cable belt, may be cleaned up by means of processing the product with a paraffinic hydrocarbon. This clean up involves the removal of water, solids and the heaviest asphaltenes from the bitumen product. Particularly beneficial for subsequent upgrading is the removal of the heavy asphaltenes that contain undesirable metals which tend to react with or interfere with catalysts used in the upgrading process of bitumen to synthetic crude oil. Paraffinic hydrocarbons that may be used for bitumen clean up include, but are not limited to, butane, pentane, hexane, heptane, octane, nonane or mixtures thereof, or natural gas condensate containing at least 50% by weight mixtures of some of these alkanes. As explained, the clean up may be done after hydrophilic solids have been removed from the bitumen product. Alternately, bitumen produced by the endless cable belt may be cleaned up with paraffinic hydrocarbons without prior hydrophilic minerals removal.

One configuration of such a method is illustrated in FIG. 7. Bitumen product 90, and a warm or cool paraffinic hydrocarbon 91 are pumped by means of a pump 93 at high velocity into a static mixer 94, for example into a serpentine conduit. This causes thorough mixing of these two components, and dissolves most of the bitumen product in paraffinic hydrocarbon whilst precipitating water, solids and a portion of the heavy asphaltenes of the bitumen product 90. The mixed and precipitated components are then separated at high speed by a first hydrocyclone to yield two product streams. From the static mixer 94 the mixture flows into the confined helical path 95 of the hydrocyclone and from there into the open vessel 96 of the hydrocyclone where it separates into an overflow 97 and an underflow 98. The overflow essentially contains paraffinic hydrocarbon and bitumen and the underflow contains mainly water, particulate solids, particulate asphaltenes and a small amount of bitumen and paraffinic hydrocarbon. The size of the hydrocyclone and flow rate through the first hydrocyclone can be adjusted to generally substantially eliminate as much as possible water, solids and precipitated asphaltenes from the overflow. Since the hydrocyclone is designed to provide a smooth transition into the confined helical path 95, to the open vessel 96 and to the underflow 98 outlet; and since flow through the hydrocyclone is fast, there is little time for asphaltene agglomeration. The precipitated asphaltenes in the underflow therefore are well dispersed and in constant motion. The overflow 97 from the first hydrocyclone can be directed to a heated still 99 or distillation tower where the mixture is separated into liquid bitumen that flows through a pipe 102 to upgrading or to tankage for long distance pipeline transport. The evaporated paraffinic hydrocarbon flows through a pipe 100 to a condenser (not shown) for reuse in the process.

One static mixer and one hydrocyclone may be sufficient or the process may be enhanced by the use of a second static mixer and hydrocyclone. In that case, the underflow 98 from the first hydrocyclone flows through a pipe 104 to a pump 105 where it is increased in pressure and may then be introduced into a second static mixer or serpentine conduit to keep the asphaltenes finely dispersed as the underflow enters the confined helical path of a second hydrocyclone. Alternately, the underflow 98 may be pumped directly into the helical confined path 107 of the second hydrocyclone. Unlike the hydrocyclones of the present invention (which are more fully described in co-pending Hydrocyclone application), conventional hydrocyclones do not do not have confined helical paths and in that case the flow is directly into the hydrocyclones in stead of through the confined helical confined paths. The overflow 110 from the second hydrocyclone consists of residual paraffinic hydrocarbon and clean bitumen and an underflow 109 of water, solids, and dispersed heavy asphaltenes flowing to disposal. The overflow 110 passes into a still 111 or distillation tower where it is separated into clean bitumen flowing from the bottom outlet 114 and a gaseous overhead 112 of paraffinic hydrocarbons which are condensed and reused in the process. Since the flow in both hydrocyclones is adjusted to eliminate all or nearly all dispersed heavy asphaltenes, solids and water, conventional stills or distillation apparati may be used to recover the paraffinic hydrocarbon provided these are designed to accommodate a small amount of solid asphaltenes. A defoaming agent may be added to the bitumen/paraffin feed or to the overflows 97 and 110 to enhance the distillation. Heating coils 101 and 113 are shown in the drawing by way of illustration to indicate that the overflows or the stills/towers are heated to achieve the separation. When only one hydrocyclone is used, underflow 98 from this hydrocyclone flows to a suitable disposal site, tailings pond or the like.

It should be noted that, while the system of FIG. 7 is specifically designed for use with liquid bitumen product recovered from an oleophilic endless cable belt it could also be used with bitumen froth or with bitumen products from other processes.

Of course, it is to be understood that the above-described arrangements, and specific examples and uses, are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A process for substantially isoelectric separation of an oil sand slurry comprising:
a) mining an oil sand ore to form a mined oil sand ore, said mining occurring on an exposed earth surface or underground;
b) transporting the mined oil sand ore to a crusher;
c) crushing the mined oil sand ore to form a crushed ore in a size suitable for unobstructed pipeline slurry transport;
d) mixing the crushed ore with water to form a slurry;
e) transporting the slurry through a pipe configured to digest the slurry into a digested slurry of discrete bitumen and solids particles dispersed in an aqueous medium;
f) passing the digested slurry through one or more hydrocyclones to produce an aqueous underflow of coarse solids including sand and a de-sanded aqueous overflow of bitumen droplets and fine solids;
g) dewatering the aqueous underflow using a revolving belt filter or a short term tailings pond;
h) passing the de-sanded aqueous overflow to and/or through a revolving oleophilic device having gaps or apertures through which the overflow passes and wherein a bitumen product is retained on oleophilic members and a de-sanded tailings product which flows through the gaps or apertures, said bitumen product containing dispersed water, oleophilic and hydrophilic solids; and
i) recovering the bitumen product from the oleophilic members.

2. The process of claim 1, wherein the pipe includes a sinusoidal pipe

3. The process as in claim 1, further comprising coarse screening the digested slurry to remove large rocks and undigested lumps prior to passing it to one or more hydrocyclones or prior to introduction into the pipeline.

4. The process as in claim 1, wherein the revolving oleophilic device is a revolving endless oleophilic belt and the oleophilic members are multiple wraps of one or more endless cables having gaps between adjacent wraps.

5. The process as in claim 1, further comprising the step of dewatering the de-sanded tailings product using a revolving belt filter or a short term tailings pond.

6. The process as in claim 5, wherein the de-sanded tailings product is dewatered using a revolving belt filter and further comprises depositing the de-sanded tailings product on top of a layer of underflow, said layer of underflow comprising at least a portion of the aqueous underflow, such that the layer of underflow serves as a filtering medium or filtering aid for the de-sanded tailings product.

7. The process as in claim 5, wherein the de-sanded tailings product is dewatered by a short term tailings pond and at least a portion of dykes defining boundaries of the tailings pond are formed from the dewatered underflow.

8. The process as in claim 5, wherein water from dewatering underflow and from dewatering de-sanded tailings product is reused in the process.

9. The process as in claim 1, wherein the process is substantially free of caustic soda.

10. The process as in claim 8, wherein air is not specifically added to the slurry and the process is substantially free of froth.

11. The process as in claim 1, further comprising the step of cleaning up the bitumen product by:
a) mixing the bitumen product in a static mixer with a paraffinic hydrocarbon sufficient to dissolve bitumen to form a dissolved bitumen mixture and to precipitate water, solids and asphaltenes from the bitumen product;
b) at least partly separating the dissolved bitumen mixture from the precipitated water, solids and asphaltenes using a first hydrocyclone to form a primary dissolved bitumen mixture and an underflow of residual dissolved bitumen and the precipitated water, solids and asphaltenes;
c) separating the dissolved bitumen from the paraffinic hydrocarbon in a still or distillation tower to form a separated bitumen;
d) storing the separated bitumen, transporting the separated bitumen by long distance pipeline, or upgrading the separated bitumen to synthetic crude oil; and
e) recycling the paraffinic hydrocarbons.

12. The process as in claim 10, further comprising at least partly separating the underflow using a second hydrocyclone to form a secondary dissolved bitumen mixture and separating the paraffinic hydrocarbon from the secondary dissolved bitumen mixture using a second still or distillation tower to form a secondary separated bitumen.

13. The process as in claim 10, wherein the paraffinic hydrocarbon is selected from the group consisting of butane, propane, pentane, hexane, heptane, octane, nonane and mixtures thereof.

14. The process as in claim 10, wherein the paraffinic hydrocarbon is a natural gas condensate containing at least 50 wt % paraffinic hydrocarbons.

15. The process as in claim 10, wherein the hydrocyclone is provided with a helical confined path to enhance separating the dissolved bitumen mixture.

16. The process as in claim 1, further comprising washing the bitumen product to remove hydrophilic particulates by mixing the bitumen product with water to form a washed bitumen product and recovering the washed bitumen product using oleophilic members.

17. A system for substantially isoelectric separation of an oil sand slurry, comprising:
a) a crusher and/or screen configured to reduce a mined oil sand to a crushed ore having a size suitable for unobstructed pipeline slurry transport;
b) a pipe operatively connected to the crusher;
c) at least one hydrocyclone fluidly connected to the pipe, said hydrocyclone having an underflow outlet for a coarse sand and solids mixture in water and an overflow outlet for a mixture in water of dispersed bitumen and desanded tailings;
d) a revolvable oleophilic device operatively connected to the overflow outlet, said revolvable oleophilic device having gaps or apertures; and
e) a dewatering device operatively connected to the underflow outlet.

18. The system of claim 17, wherein the pipe includes a sinusoidal pipe configured as a repeating sinusoidal wave in a two-dimensional plane sufficient to restrict a line of sight down the length of the sinusoidal pipe.

19. The system of claim 18, wherein the sinusoidal pipe further comprises one or more auxiliary inlets and/or outlets in fluid communication with an interior of the conduit and remote from either end of the sinusoidal pipe.

20. The system of claim 17, wherein the at least one hydrocyclone comprises a substantially open cylindrical vessel having an open vessel inlet configured to introduce a fluid tangentially into the open vessel and a helical confined path connected upstream of the open vessel at the open vessel inlet.

21. The system of claim 17, wherein said revolvable oleophilic device is an endless oleophilic belt formed from multiple wraps of one or more endless cables wrapped around at least two revolvable cylindrical members to form a plurality of gaps between adjacent windings.

22. The system of claim 21, wherein at least one of the revolvable cylindrical members is an agglomerator drum having openings oriented in fluid communication with the endless cable to allow passage of fluid from an interior to an exterior of the agglomerator drum and including oleophilic members for adhering oleophilic material.

23. The system of claim 17, wherein the dewatering device is a revolving belt filter, short term tailings pond, or a water runoff system.

24. The system of claim 17, wherein the de-sanded tailings are further operatively connected to the dewatering device or a secondary dewatering device.

25. The system of claim 17, further comprising a secondary sinusoidal pipe operatively connected to the revolvable endless oleophilic belt and configured to increase transfer of hydrophilic solids in recovered bitumen to an aqueous phase.

26. The system of claim 17, further comprising a secondary hydrocyclone operatively connected to the overflow of the hydrocyclone.
